(19) United States
(12) Patent Application Publication
(10) Pub. No.: US 2020/0247194 A1
(43) Pub. Date: Aug. 6, 2020

(54) AUTOMATIC TIRE INFLATION SYSTEM FOR AN AGRICULTURAL IMPLEMENT

(71) Applicant: CNH INDUSTRIAL CANADA, LTD., Saskatoon (CA)

(72) Inventor: Dennis George Thompson, Eagle Ridge (CA)

(73) Assignee: CNH INDUSTRIAL CANADA, LTD.

(21) Appl. No.: 16/263,171

(22) Filed: Jan. 31, 2019

(51) Int. Cl. B60C 23/00

(52) U.S. Cl. CPC B60C 23/004; B60C 23/02; B60C 23/002

(57) ABSTRACT

An automatic tire inflation system for an agricultural implement is provided. The automatic tire inflation system includes a first sensor configured to detect a weight of the agricultural implement. The automatic tire inflation system also includes a controller configured to receive feedback from the first sensor and to automatically adjust a pressure of one or more tires of a plurality of tires coupled to the agricultural implement based on at least the weight of the agricultural implement.

### BACKGROUND

The disclosure relates generally to an agricultural implement and, more specifically, to an automatic tire inflation system for an agricultural implement.

Generally, an agricultural implement may be towed behind an off-road vehicle, such as a tractor, in a field or in some cases on a road. In certain cases, more than one agricultural implement may be towed. For example, a seed drill, an air cart, and/or a fertilizer wagon may be coupled in series behind the towing vehicle. Implements may have a significantly different or variable mass between a fully loaded condition and an empty condition that require different tire inflation pressures. For towed seeding implements (e.g., air carts), the overall mass may vary up to approximately 27,215 kilograms (approximately 60,000 pounds) or more when fully loaded as compared to when it's empty. Since tires need to be inflated to a required pressure for fully loaded conditions, as the weight of the implement lessens, the tires become overinflated and, thus, are not operating at the optimal pressure to maximize footprint and to minimize ground compaction. In some agricultural areas, soil compaction has become a major concern.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In one embodiment, an agricultural implement is provided. The agricultural implement includes an automatic tire inflation system configured to adjust a pressure of one or more tires of a plurality of tires coupled to the agricultural implement. The agricultural implement also includes a first sensor configured to detect a weight of the agricultural implement. The agricultural implement further includes a controller configured to receive feedback from the first sensor and to automatically adjust the pressure of the one or more tires based on at least the weight of the agricultural implement.

In another embodiment, an automatic tire inflation system for an agricultural implement is provided. The automatic tire inflation system includes a first sensor configured to detect a weight of the agricultural implement. The automatic tire inflation system also includes a controller configured to receive feedback from the first sensor and to automatically adjust a pressure of one or more tires of a plurality of tires coupled to the agricultural implement based on at least the weight of the agricultural implement.

In a further embodiment, a method for utilizing an automatic tire inflation system for an agricultural implement is provided. The method includes receiving, at a controller, a first signal representative of a weight of the agricultural implement from a first sensor disposed on the agricultural implement. The method also includes automatically adjusting, via the controller, a pressure of one or more tires of a plurality of tires coupled to the agricultural implement based on at least the weight of the agricultural implement.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system with an agricultural implement having an automatic tire inflation system, in accordance with an aspect of the present disclosure;

FIG. 2 is a side view of an embodiment of an air cart that may employ the automatic tire inflation system, in accordance with an aspect of the present disclosure;

FIG. 3 is a schematic view of an embodiment of an agricultural implement having the automatic tire inflation system, in accordance with an aspect of the present disclosure;

FIG. 4 is a flowchart of an embodiment of a method for utilizing the automatic tire inflation system of FIG. 3, in accordance with an aspect of the present disclosure; and

FIG. 5 is a flowchart of an embodiment of a method for utilizing the automatic tire inflation system of FIG. 3 (e.g., utilizing multiple parameters in adjusting tire pressure), in accordance with an aspect of the present disclosure

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

With the significant difference in weight between a fully loaded implement (e.g., air cart) and an empty implement, there can be a significant difference between the required tire pressures for each condition. For example, the tire pressure under the fully loaded condition may result in overinflated tires when the implement weighs less, which leads to not operating at the optimal tire pressure. In particular, there is a need for the pressure of the tires of the implement to be adjusted as the weight of the implement changes to enable operation at an optimal tire pressure to maximize the tire footprint and to minimize ground compaction.

Accordingly, as will be described in more detail below, embodiments described herein provide an automatic tire inflation system (e.g., automatic tire pressurization system). For example, an agricultural implement may include an on-board automatic tire inflation system that is responsive to a change in weight of the agricultural implement and increases or decreases the tire inflation pressure in response. In certain embodiments, the automatic tire inflation system may take into account other parameters such as the incline of the implement, speed of the implement, tire size, machine size or capacity, or other factors. In certain embodiments, the automatic tire inflation system may include a reservoir or storage vessel for air released from the tires which may be utilized to inflate the tires or for an on-board air cleaning system (e.g., utilizing an air wand). In certain embodiments, the automatic tire inflation system may provide a warning to an operator to adjust a speed of the towing vehicle (and the agricultural implement) to enable the pressure of the tires to be adjusted. Utilization of the automatic tire inflation system enables operation of the implement at an optimal tire pressure to maximize the tire footprint and to minimize ground compaction. In addition, the automatic tire inflation system may improve overall transport safety by ensuring proper tire inflation pressure for the transporting speed.

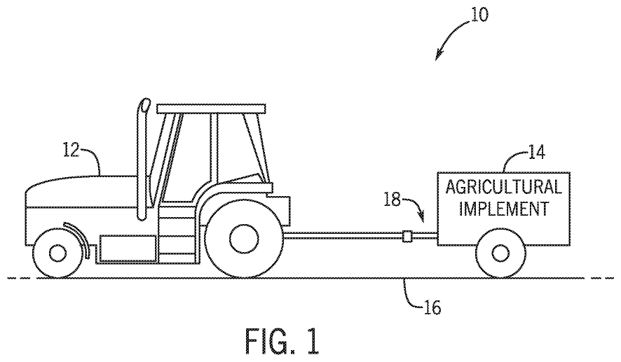

FIG. 1 is a side view of an embodiment of an agricultural system 10. The agricultural system 10 includes a tow vehicle 12 and an agricultural implement 14. The tow vehicle 12 may be any vehicle suitable for towing the agricultural implement 14, such as a tractor, off-road vehicle, work vehicle, and so forth. Additionally, the agricultural implement 14 may be any implement suitable for agricultural use, such as a tillage implement, a fertilizer implement, an air cart, or another agricultural implement. In certain embodiments, one or more additional implements may be coupled to and towed behind the agricultural implement 14. The agricultural system 10 travels over a surface 16, such as the ground, a road, a field, or another surface. The tow vehicle 12 is coupled to the agricultural implement 14 by a hitch assembly 18 (e.g., hitch).

In certain scenarios, one or more operating parameters may change relating to the agricultural implement 14 (e.g., weight, speed, incline, etc.). As described in greater detail below, the agricultural implement 14 includes an automatic tire inflation or pressurization system. The automatic tire inflation system may be utilized to automatically adjust (e.g., free of operator input) the pressure of the tires of the agricultural implement 14 via inflation or deflation to ensure optimal tire pressure. In certain embodiments, the tow vehicle 12 may include an automatic tire inflation system similar to the one described below. In certain embodiments, the tow vehicle 12 may include a device (e.g., screen, indicator, etc.) to provide an indication or warning that the speed of the tow vehicle 12 and the agricultural implement 14 should be adjusted to safely operate at the current tire pressure.

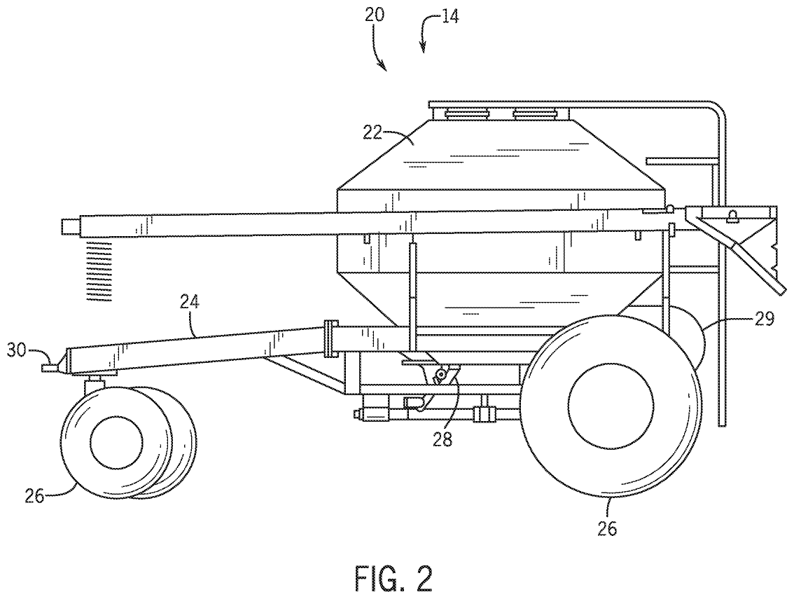

An example of the agricultural implement 14 (e.g., large agricultural implement) that includes the dedicated, on-board automatic tire inflation system is provided in FIG. 2. FIG. 2 illustrates a side view of an air cart 20 that may be used in conjunction with a towable agricultural implement to deposit seeds into the soil. More specifically, the air cart 20 may be used to centrally store seeds and distribute the seeds to the agricultural implement. Accordingly, in the illustrated embodiment, the air cart 20 includes a storage tank 22, a frame 24, tires 26, a metering assembly 28, and an air source 29. In the depicted embodiment, the air cart frame 24 may be coupled to another agricultural implement or an off-road work vehicle (i.e., towing vehicle) via a hitch 30. As such, the tires 26 may contact the soil surface to enable the air cart 20 to be towed. The hitch 30 may include one or more electronic sensors or actuators disposed on it to sense compression or tension forces and the air cart 20 may include the dedicated, on-board implement braking system as described in greater detail below.

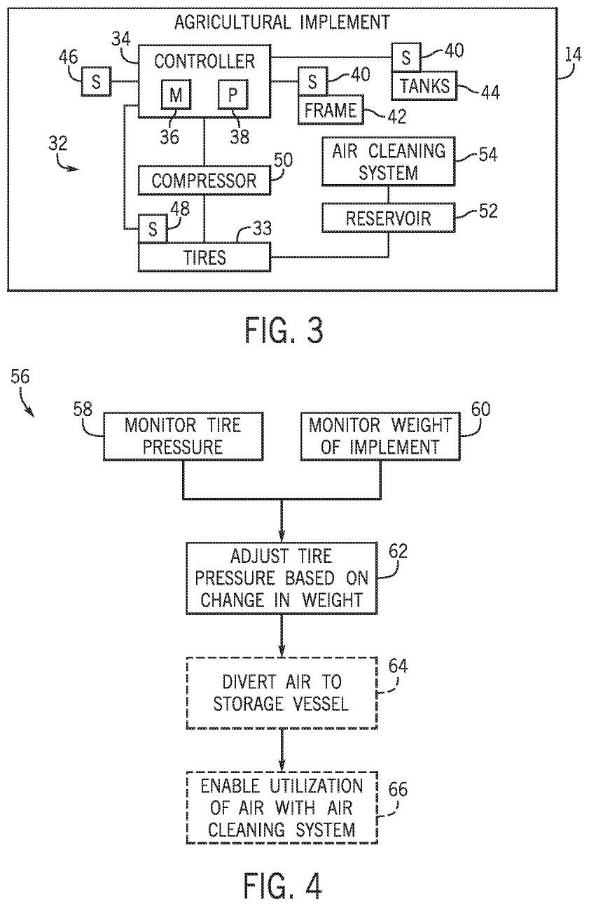

To more clearly illustrate, a schematic view of the agricultural implement 14 having a dedicated, on-board automatic tire inflation system is provided in FIG. 3. As illustrated, the agricultural implement 14 includes an automatic tire inflation system 32 for inflating or deflating a plurality of tires 33 coupled to the implement 14 based on one or more parameters related to the implement 14. The automatic tire inflation system 32 includes a controller 34. The controller 34 includes a memory 36 and a processor 38. In some embodiments, the processor 38 may include one or more general purpose processors, one or more application specific integrated circuits, one or more field programmable gate arrays, or the like. Additionally, the memory 36 may be any tangible, non-transitory, computer readable medium that is capable of storing instructions executable by the processor 38 and/or data that may be processed by the processor 38. In other words, the memory 36 may include volatile memory, such as random access memory, or non-volatile memory, such as hard disk drives, read only memory, optical disks, flash memory, and the like. In certain embodiments, the memory 36 may store various parameters related to the agricultural implement 14. For example, these parameters may include an incline of the implement 14, a size or capacity of the implement 14, a tire load for each tire 33 based on speed, tire size, the baseline weight of the implement 14, and other factors. The memory 36 may also store tables. For example, a table may provide specific tire pressures for one or more parameters related to the agricultural implement 14. A table may also provide maximum speeds for specific tire pressures.

The automatic tire inflation system 32 also includes one or more sensors 40 (e.g., load cells, weight scale system, etc.) coupled to a frame 42 and/or one or more storage tanks 44 (if present) to measure a weight of the implement 14. In certain embodiments, the implement 14 includes a baseline weight (which the controller 34 may access in the memory 36) and the sensors 40 measure any additional weight placed on the frame 42 and/or within the one or more storage tanks 44. The weight of each tank 44 may vary based on the amount of product within the tank 44. In certain embodiments, the controller 32 may determine the weight of the agricultural implement 14 based on a combination of the baseline weight of the implement 14 and the feedback from the one or more sensors 40.

In certain embodiments, the automatic tire inflation system 32 further includes one or more additional sensors 46 to measure other parameters related to the implement 14. In certain embodiments, the additional sensors 46 may include a sensor (e.g., accelerometer, GPS, or Hall effect sensor) to measure the speed of the implement 14 or a sensor to determine the incline or angle of the implement 14. In certain embodiments, the speed of the implement 14 may be provided via feedback from a vehicle towing the implement 14. The automatic tire inflation system 32 also includes respective sensors 48 coupled to respective tires 33 to measure the pressures of the tires 33. The sensors 40, 46, 48 may communicate via a wired connection or wireless connection (e.g., via transceivers) with the controller 34.

The controller 34 is configured to automatically adjust the respective tire pressures of the tires 33 based on the feedback from the sensors 40, 46, 48 and/or the parameters related to the implement 14 stored in the memory 36. In certain embodiments, the controller 34 is configured to adjust the tire pressures based solely on the weight of the agricultural implement 14 (utilizing the baseline weight in the memory 36 and/or the feedback from the sensors 40). In certain embodiments, the controller 34 is configured to adjust the tire pressures based on both the weight of the agricultural implement 14 and the speed of the agricultural implement 14 (e.g., via feedback from the sensors 46). In certain embodiments, the controller 34 is configured to adjust the tire pressures based on a combination of the weight of the agricultural implement 14, the speed of the implement 14, and other parameters related to implement 14 (e.g., incline, tire size, machine size/capacity, tire load, etc.). The controller 34 is configured to independently adjust the tire pressures of each respective tire 33. For example, the front tires 33 on the implement 14 may have different pressure requirements than the rear tires 33.

In certain embodiments, the controller 34 is configured to engage the automatic tire inflation system 32 once the agricultural implement 14 (e.g., air cart) is fully loaded to adjust the pressure of the tires 33 to the needed pressure levels based on the load carrying requirements. In other embodiments, the controller 34 engages the automatic tire inflation system 32 as the agricultural implement 14 is being loaded with the product. In certain embodiments, upon movement of the agricultural implement 14, the controller 34 is configured to monitor the pressure of the tires 33 and adjust the pressure to match the vehicle speed, tire load, and load carrying capability of the tire based on speed. In certain embodiments, the adjustment in tire pressure via the automatic tire inflation system 32 may not be quick enough. If not, the controller 34 may provide a warning to an operator (e.g., via a device on the operator or on the towing vehicle being driven by the operator) to indicate a certain maximum speed based on the current tire pressures and/or implement weight. Upon the tires 33 being properly adjusted, this warning will be removed by the controller 34.

The automatic tire inflation system 32 includes a compressor 50 coupled to the controller 34. The compressor 50 provides pressurized air to the tires 33. In certain embodiments, air released from the tires 33 during deflation may be stored in a reservoir or vessel 52. In certain embodiments, the air stored within the vessel 52 may be utilized in the inflation of the tires 33. In certain embodiments, the vessel 52 may be stored in one or more of the tires 33 (e.g., as a bladder). In certain embodiments, the air within the vessel 52 (whether separate from the tires 33 or within one or more tires 33) may be utilized in an air cleaning system 54 (e.g., wand-based air cleaning system) to clean components of the agricultural implement 14 (e.g., tanks 44, etc.).

FIG. 4 is a flowchart of an embodiment of a method 56 for utilizing the automatic tire inflation system 32 of FIG. 3. The steps of the method 56 may be performed by the controller 34 of the agricultural implement 14 described above. One or more of the steps of the method 56 may be performed simultaneously or in a different order. The method 56 includes monitoring the tire pressure 58 of the tires 33 coupled to the agricultural implement 14 (block 58). Monitoring the tire pressure 58 may include receiving feedback from the sensors 48 coupled to the tires 33. The method 56 also includes monitoring a weight of the agricultural implement 14 (block 60). Monitoring the weight of the implement 14 may include receiving feedback form the sensors 40 and/or obtaining a baseline weight from the memory 36. The method 56 further includes adjusting the tire pressure of one or more of the tires 33 based on a change in the weight of the agricultural implement 14 (block 62). In certain embodiments, when the tires 33 are being deflated, the method 56 includes diverting the air to the reservoir or vessel 52 (block 64). The air within the vessel 52 may be utilized for inflation of the tires 33. In certain embodiments, the method 56 includes enabling the utilization of the air within the vessel 52 with the air cleaning system 54 to clean components of the agricultural implement 14 (block 66).

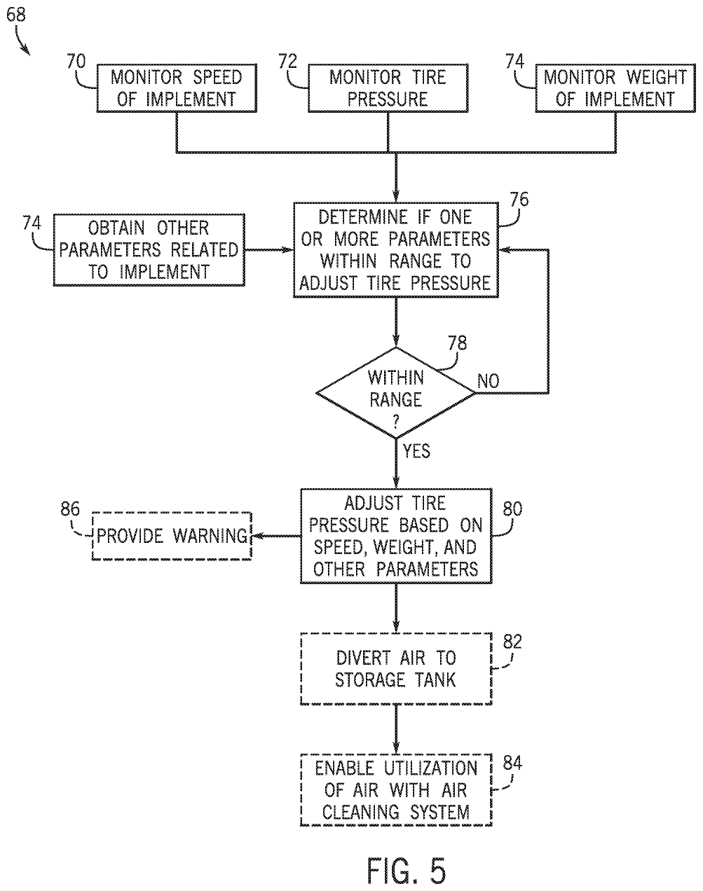

FIG. 5 is a flowchart of an embodiment of a method 68 for utilizing the automatic tire inflation system 32 of FIG. 3 (e.g., utilizing multiple parameters in adjusting tire pressure). The steps of the method 68 may be performed by the controller 34 of the agricultural implement 14 described above. One or more of the steps of the method 68 may be performed simultaneously or in a different order. The method 68 includes monitoring a speed of the agricultural implement 14 (block 70). Monitoring the speed may include receiving feedback form the sensors 46. In certain embodiments, feedback related to the speed may be provided from the towing vehicle. The method 56 also includes monitoring the tire pressure 58 of the tires 33 coupled to the agricultural implement 14 (block 72). Monitoring the tire pressure 58 may include receiving feedback from the sensors 48 coupled to the tires 33. The method 56 also includes monitoring a weight of the agricultural implement 14 (block 74). Monitoring the weight of the implement 14 may include receiving feedback form the sensors 40 and/or obtaining a baseline weight from the memory 36.

In certain embodiments, the method 68 includes obtaining one or more other parameters related to the agricultural implement 14 (block 74). For example, an incline, a tire size, tire load, machine size/capacity, or other parameters may be obtained from the memory 36. The method 68 further includes determining whether one or more parameters (e.g., speed and/or weight) of the agricultural implement 14 fall within respective ranges for adjusting the tire pressure in light of the other parameters (e.g., tire size, tire load, machine size/capacity, etc.) (block 76). Upon a determination of whether the one or more parameters are within range (block 78), if the one or more parameters or not within range, the method 68 includes continuing the determination (block 76). However, if the one or more parameters are within range, the method 68 includes adjusting the tire pressure of one or more of the tires 33 based on a change in the weight of the agricultural implement 14 (block 80). In certain embodiments, when the tires 33 are being deflated, the method 68 includes diverting the air to the reservoir or vessel 52 (block 82). The air within the vessel 52 may be utilized for inflation of the tires 33. In certain embodiments, the method 64 includes enabling the utilization of the air within the vessel 52 with the air cleaning system 54 to clean components of the agricultural implement 14 (block 84). In certain embodiments, if the adjustment of the tire pressures cannot occur soon enough in response to a change in speed of the agricultural implement 14, the method 68 includes providing a warning to the operator (block 86). In particular, on a device on the operator or on the towing vehicle (e.g., screen, indicator, etc.), a warning may be provided that includes a recommendation of a maximum speed for transport of the agricultural implement 14 based on current pressures of the plurality of tires 33 and the weight of the implement 14.

While only certain features of the disclosure have been illustrated and described herein, many modifications and changes will occur to those skilled in the art. It is, therefore, to be understood that the appended claims are intended to cover all such modifications and changes as fall within the essence of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An agricultural implement, comprising:
an automatic tire inflation system configured to adjust a pressure of one or more tires of a plurality of tires coupled to the agricultural implement, comprising:
a first sensor configured to detect a weight of the agricultural implement; and
a controller configured to receive feedback from the first sensor and to automatically adjust the pressure of the one or more tires based on at least the weight of the agricultural implement.

2. The agricultural implement of claim 1, wherein the controller is configured to automatically adjust different tires of the plurality of tires to different air pressures.

3. The agricultural implement of claim 1, comprising a second sensor configured to detect a speed of the agricultural implement.

4. The agricultural implement of claim 4, wherein the controller is configured to receive feedback from the second sensor and to automatically adjust the pressure of the one or more tires based on at least the weight and the speed of the agricultural implement.

5. The agricultural implement of claim 3, wherein the controller is configured to obtain other parameters related to the agricultural implement and to automatically adjust the pressure of the one or more tires based on at least the weight, the speed, and the other parameters of the agricultural implement.

6. The agricultural implement of claim 5, wherein the other parameters comprise incline, tire size, machine size, machine capacity, or tire load.

7. The agricultural implement of claim 1, wherein the controller is configured to provide a warning signal to an operator providing a recommendation of a maximum speed for transport of the agricultural implement based on current pressures of the plurality of tires and the weight of the agricultural implement.

8. The agricultural implement of claim 1, wherein the automatic tire inflation system comprises a compressor to provide air for inflation of the one or more tires.

9. The agricultural implement of claim 1, wherein the automatic tire inflation system comprises a storage vessel for storing and providing air to an on-board air cleaning system of the agricultural implement.

10. The agricultural implement of claim 9, wherein the one or more tires comprise the storage vessel.

11. The agricultural implement of claim 1, wherein the agricultural implement comprises an air cart.

12. An automatic tire inflation system for an agricultural implement, comprising:
a first sensor configured to detect a weight of the agricultural implement; and
a controller configured to receive feedback from the first sensor and to automatically adjust a pressure of one or more tires of a plurality of tires of the agricultural implement based on at least the weight of the agricultural implement.

13. The agricultural implement of claim 12, comprising a second sensor configured to detect a speed of the agricultural implement.

14. The agricultural implement of claim 13, wherein the controller is configured to receive feedback from the second sensor and to automatically adjust the pressure of the one or more tires based on at least the weight and the speed of the agricultural implement.

15. The agricultural implement of claim 13, wherein the controller is configured to obtain other parameters related to the agricultural implement and to automatically adjust the pressure of the one or more tires based on at least the weight, the speed, and the other parameters of the agricultural implement.

16. The agricultural implement of claim 15, wherein the other parameters comprise incline, tire size, machine size, machine capacity, or tire load.

17. The agricultural implement of claim 12, wherein the controller is configured to provide a warning signal to an operator providing a recommendation of a maximum speed for transport of the agricultural implement based on current pressures of the plurality of tires and the weight of the agricultural implement.

18. The agricultural implement of claim 12, wherein the automatic tire inflation system comprises a compressor to provide air for inflation of the one or more tires.

19. A method for utilizing an automatic tire inflation system for an agricultural implement, comprising:
receiving, at a controller, a first signal representative of a weight of the agricultural implement from a first sensor disposed on the agricultural implement; and
automatically adjusting, via the controller, a pressure of one or more tires of a plurality of tires coupled to the agricultural implement based on at least the weight of the agricultural implement.

20. The method of claim 19, comprising:
receiving, at the controller, a second signal representative of a speed of the agricultural implement from a second sensor disposed on the agricultural implement; and
automatically adjusting, via the controller, the pressure of one or more tires based on at least the weight and the speed of the agricultural implement.
